(19) United States
(12) Patent Application Publication
(10) Pub. No.: US 2010/0080716 A1
(43) Pub. Date: Apr. 1, 2010

(54) ROTOR AND COOLING FAN HAVING THE SAME

(75) Inventors: KUAN-TENG TSAI, Tu-Cheng (TW); JR-SHIUN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng,Taipei Hsien (TW)

(21) Appl. No.: 12/498,375

(22) Filed: Jul. 7, 2009

(30) Foreign Application Priority Data
Sep. 26, 2008 (CN) 200810304698.0

(51) Int. Cl. F04D 25/08; H02K 1/30

(52) U.S. Cl. 417/354; 310/156.12

(57) ABSTRACT

A cooling fan includes a base, a stator mounted on the base and a rotor rotatablely supported by the stator. A central tube is formed at a central portion of the base for mounting the stator thereon. The rotor includes a hub, a hollow shell, a permanent magnet and a plurality of blades. The hub includes a top wall and a sidewall extending downwardly from an outer periphery of the top wall. The shell is attached to an inner surface of the sidewall of the hub. An annular bottom flange is formed at a bottom end of the shell. The permanent magnet is attached to an inner surface of the shell. The permanent magnet extends to abut directly against a bottom surface of the top wall of the hub.

### BACKGROUND

1. Technical Field

The present disclosure relates to cooling fans, and particularly to a cooling fan which has an improved rotor.

2. Description of Related Art

With continuing development of electronic technology, heat-generating electric components such as CPUs (central processing units) are generating more and more heat which requires immediate dissipation. Cooling fans are commonly used to cool the CPUs.

A conventional cooling fan includes a stator and a rotor rotatably supported by the stator. The rotor includes a hub, a shell, a permanent magnet and a plurality of blades. The hub is hollow, including a circular top wall and a cylindrical sidewall extending downwardly from an outer periphery of the top wall. The blades extend outwardly and radially from an outer surface of the sidewall of the hub. The shell is of a magnetic conductive material and includes a cylindrical main wall attached to an inner surface of the sidewall of the hub and an annular top flange extending inwardly from a top end of the main wall. When assembled, the shell is received in the hub with the top flange abutting against a bottom surface of the top wall of the hub and the main wall attached to the inner surface of the sidewall of the hub. The permanent magnet is then attached to an inner surface of the main wall of the shell with a top end abutting against the top flange of the shell. The top flange is thus sandwiched between the top end of the permanent magnet and the top wall of the hub, which limits an extension of the permanent magnet to the bottom surface of the top wall of the hub. Thus, a barycenter of the permanent magnet is relatively low. A magnetic offset between the stator and the permanent magnet of the rotor is accordingly reduced, to thereby weaken an attraction between the stator and the rotor and easily cause a shake of the rotor when the rotor rotates at a high speed. As a result, a noise may be produced. Furthermore, when the cooling fan is used inversely, the rotor may fall off from the stator because the attraction is weak.

Therefore, there is a need in the art for a cooling fan having an improved rotor which can overcome the above describe shortcomings.

### BRIEF DESCRIPTION OF THE DRAWINGS

FIG. 1 is a cross-sectional view of a cooling fan in accordance with an exemplary embodiment of this disclosure.

FIG. 2 is an isometric view of a magnet unit of the cooling fan of FIG. 1.

FIG. 3 is a cross-sectional view of the magnet unit of FIG. 2.

### DETAILED DESCRIPTION

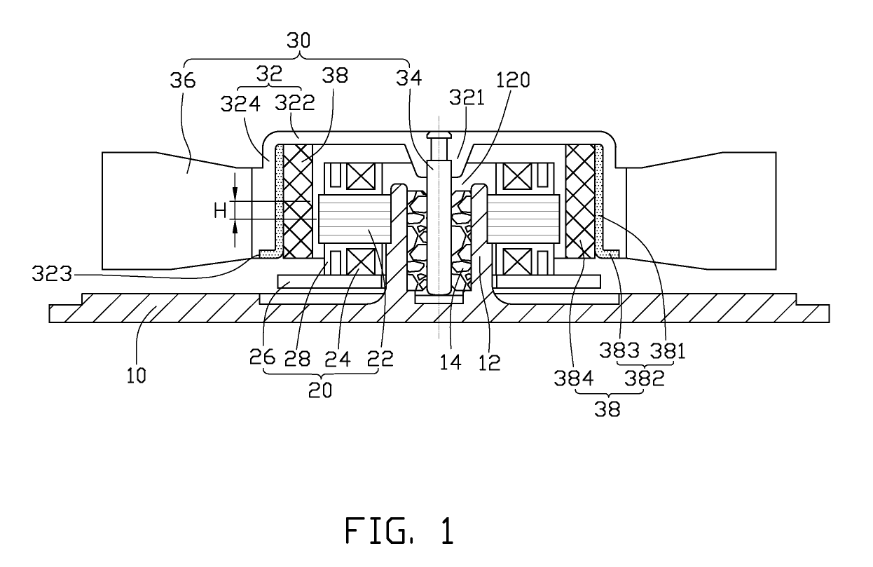

FIG. 1 shows a cooling fan in accordance with an exemplary embodiment of the disclosure. The cooling fan can be an axial fan or a centrifugal fan, and includes a base 10, a stator 20 and a rotor 30 rotatablely supported by the stator 20.

The base 10 includes a central tube 12 extending upwardly from a central portion thereof. The stator 20 is mounted around the central tube 12. The central tube 12 is hollow and defines a receiving hole 120 therein. An upper end of the central tube 12 is open. A bearing 14 is received in the receiving hole 120 of the central tube 12. An outer diameter of the bearing 14 is substantially the same as the diameter of the receiving hole 120.

The stator 20 includes a stator core 22, a plurality of stator coils 24, a PCB 26 (printed circuit board) and an insulating frame 28. The stator core 22 is arranged at a top side of the PCB 26. The stator coils 24 are wound on the stator core 22. The PCB 26 with electronic components (not shown) mounted thereon is electrically connected with the stator coils 24 to provide electrical current to the stator coils 24. The insulating frame 28 is used to cover the stator core 22 to avoid contact between the coils 24 and the stator core 22, thus to electrically insulate the coils 24 from the stator core 22.

The rotor 30 includes a hub 32, a shaft 34, a plurality of blades 36 and a magnet unit 38. The hub 32 is cylindrical, including a circular top wall 322 and a cylindrical sidewall 324 extending downwardly from an outer periphery of the top wall 322. The top wall 322 and the sidewall 324 cooperatively define a space in the hub 32 for receiving the magnet unit 38 and the stator 20 therein. A shaft seat 321 protrudes downwardly from a central portion of a bottom surface of the top wall 322 of the hub 32. The shaft 34 extends downwardly and perpendicularly from the shaft seat 321, and includes a fixed end connected with the shaft seat 321 and a free end away from the shaft seat 321. The sidewall 324 defines an annular recess 323 at a bottom end thereof. The annular recess 323 communicates with the space of the hub 32. The magnet unit 38 is attached to an inner surface of the sidewall 324 of the hub 32. The blades 36 extend radially and outwardly from an outer surface of the sidewall 324 of the hub 32.

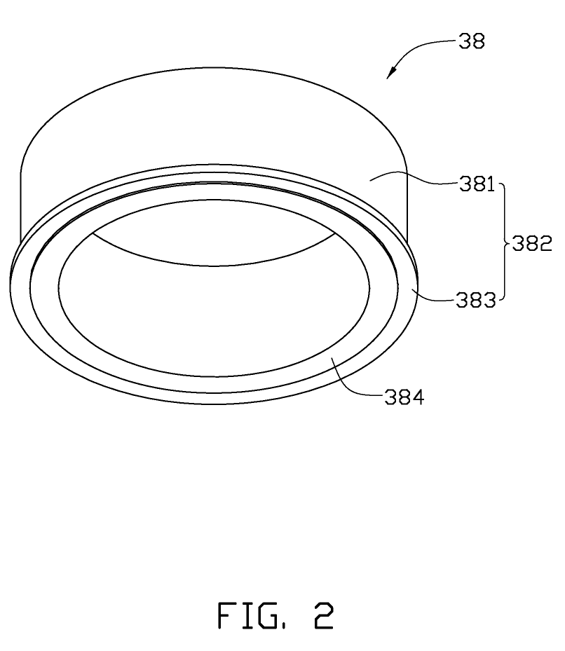

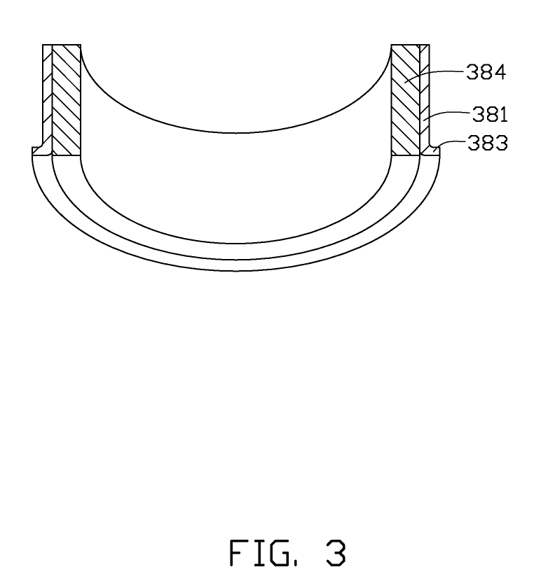

Referring to FIGS. 2 and 3, the magnet unit 38 as a whole is approximately cylindrical. The magnet unit 38 includes a hollow shell 382 and a cylindrical permanent magnet 384 received in the shell 382. The shell 382 includes a cylindrical main body 381 and an annular bottom flange 383 extending perpendicularly and outwardly from a bottom end of the main body 381. The annular bottom flange 383 enhances a strength of the shell 382 for preventing the shell 382 from deformation. The permanent magnet 384 is attached to an inner surface of the shell 382. A height of the permanent magnet 384 is substantially the same as that of the shell 382. Top and bottom ends of the permanent magnet 384 are respectively coplanar to top and bottom ends of the shell 382.

Referring back to FIG. 1, in assembly, the magnet unit 38 is fixedly attached to an inner surface of the sidewall 324 of the hub 32. The top end of the permanent magnet 384 abuts directly against a bottom surface of the top wall 322 of the hub 32. The main body 381 of the shell 382 is sandwiched between the permanent magnet 384 and the sidewall 324 of the hub 32. The annular bottom flange 383 of the shell 382 is fittingly received in the annular recess 323 of the sidewall 324 of the hub 32.

The stator 20 is mounted on the central tube 12 of the base 10. The rotor 30 covers the stator 20 with the sidewall 324 of the hub 32 surrounding the stator 20. The permanent magnet 384 is spaced from the stator 20 and just faces a lateral periphery of the stator 20. The free end of the shaft 34 extends into a center hole of the bearing 14. A diameter of the shaft 34 is approximately the same as an inner diameter of the bearing 14, and the shaft 34 is thus rotatablely supported by the bearing 14. Thus, the rotor 30 is rotatable with respect to the stator 20.

Since the top end of the permanent magnet 384 extends to abut directly against the bottom surface of the top wall 322 of the hub 32, a center of mass of the permanent magnet 384 along an axial direction of the cooling fan moves upwardly for a certain distance with respect to a center of mass of the stator 20. A height offset H between the centers of mass of the permanent magnet 384 and the stator 20 is thus formed, whereby an attracting force exerted by the center of mass of the stator 20 at the center of mass of the rotor 30 can be accordingly divided into a horizontally inward component and a vertically downward component. Thus, a magnetic attraction effected on the rotor 30 by the stator 20 has a tendency to always draw the rotor 30 downwardly towards the stator 20. Thus, a risk of unstable rotation of the rotor 30 is eliminated, thereby a noise generated by an unstable rotation is accordingly eliminated.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cooling fan, comprising:
a base forming a central tube at a central portion thereof;
a stator being mounted around the central tube, and
a rotor being rotatablely supported by the stator, the rotor comprising a hub comprising a top wall and a sidewall extending downwardly from an outer periphery of the top wall, a hollow shell being attached to an inner surface of the sidewall of the hub and a permanent magnet being attached to an inner surface of the shell, the shell forming an annular bottom flange extending outwardly from a bottom end thereof, a top end of the permanent magnet extending to abut directly against a bottom surface of the top wall of the hub.

2. The cooling fan of claim 1, wherein top and bottom ends of the permanent magnet are respectively coplanar to top and bottom ends of the shell.

3. The cooling fan of claim 1, wherein the top wall of the hub is circular, and the sidewall of the hub is cylindrical, the top wall and the sidewall cooperatively define a space for receiving the stator therein.

4. The cooling fan of claim 3, wherein the sidewall of the hub defines an annular recess at a bottom end thereof for receiving the annular bottom flange of the shell therein, the annular recess communicates with the space of the hub.

5. The cooling fan of claim 1, wherein the shell includes a cylindrical main body sandwiched between the permanent magnet and the sidewall of the hub, the annular bottom flange extends radially and outwardly from a bottom end of the main body.

6. The cooling fan of claim 1, wherein the cooling fan is an axial fan.

7. The cooling fan of claim 1, wherein the cooling fan is a centrifugal fan.

8. A rotor for a cooling fan, comprising:
a hub comprising a top wall and a sidewall extending downwardly from an outer periphery of the top wall;
a hollow shell being attached to an inner surface of the sidewall of the hub, the shell forming an annular bottom flange extending radially and outwardly from a bottom end thereof; and
a permanent magnet being attached to an inner surface of the shell, a top end of the permanent magnet extending to abut directly against a bottom surface of the top wall of the hub.

9. The rotor of claim 8, wherein top and bottom ends of the permanent magnet are respectively coplanar to top and bottom ends of the shell.

10. The rotor of claim 8, wherein the top wall of the hub is circular, the sidewall of the hub is cylindrical, the sidewall of the hub defines an annular recess at a bottom end thereof for receiving the annular bottom flange of the shell therein.

11. The rotor of claim 8, wherein the shell includes a cylindrical main body sandwiched between the permanent magnet and the sidewall of the hub, the annular bottom flange extends radially and outwardly from a bottom end of the main body.
